(19) United States
(12) Patent Application Publication
(10) Pub. No.: US 2009/0315786 A1
(43) Pub. Date: Dec. 24, 2009

(54) ANTENNA WITH INCREASED ELECTRICAL LENGTH AND WIRELESS COMMUNICATION DEVICE INCLUDING THE SAME

(75) Inventors: Byung Hoon Ryou, Seoul (KR); Won Mo Sung, Gyeonggi-do (KR); Gi Ho Kim, Gyeonggi-do (KR); Yun Bok Lee, Seoul (KR); Jun Woo Park, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: E.M.W. Antenna Co., Ltd., Seoul (KR)

(21) Appl. No.: 12/281,621

(22) PCT Filed: Mar. 30, 2007
(86) PCT No.: PCT/KR07/01575

§ 371 Date: Jan. 20, 2009

(30) Foreign Application Priority Data
Mar. 31, 2006 (KR) 10-2006-0029327
Apr. 12, 2006 (KR) 10-2006-0033029

(51) Int. Cl. H01Q 1/38; H01Q 1/24; H01Q 1/40

(52) U.S. Cl. 343/702; 343/873; 343/700 MS

(57) ABSTRACT

Disclosed is an antenna with an extended electrical length, including radiators (110, 210, 310), (410 and 510) having S-shaped or spiral-shaped cells (112, 212, 312 and 512). The cells (112, 212, 312 and 512) are formed on the front surface of the boards (120, 220, 320, 420 and 520), and two or more of the cells are connected in series by connectors (114, 214 and 314) formed on the rear surface of the board. Furthermore, the antenna includes a ground stub (150) and a parasitic element (160) electromagnetically coupled to the radiators (110, 210, 310, 410 and 510), and has a good radiation characteristic. Furthermore, the antenna can include the cells (112, 212, 312 and 512) of different sizes and can thus have a multi-band characteristic.

### TECHNICAL FIELD

The present invention relates, in general, to an antenna with an extended electrical length, and more particularly, to an antenna with an increased electrical length in order to receive signals of low frequency bands, such as the VHF band while maintaining a small size.

### BACKGROUND ART

In wireless communications in which information is transmitted and received by electromagnetic waves, an antenna in which the current is directly induced by electromagnetic waves or electromagnetic waves are induced by the current must be necessarily included as the endmost element of an analog circuit. Known antenna structures include a dipole antenna, a monopole antenna and so forth. In portable wireless communication devices, the monopole antenna with a small size is preferred. The monopole antenna is designed to have the length of ¼ of a resonance wavelength (in general, a wavelength with respect to the central frequency of a target frequency band) by the mirror effect of the ground surface. Thus, the longer the wavelength of a signal used (i.e. the lower frequency of a signal), the larger the size of the monopole antenna.

Meanwhile, the VHF (Very High Frequency) band has a frequency band of 30 to 300 MHz, and has been, in general, used for FM radio broadcasting or television broadcasting. In recent years, Terrestrial Digital Multimedia Broadcasting (T-DMB) service was designated to use the VHF bands of 180 to 186 MHz and 204 to 210 MHz. Thus, active research has been done in terminals for receiving the signals of the VHF bands and antennas therefor.

The signals of the VHF bands have a very low frequency, that is, a very long wavelength compared with a frequency band for cellular service of a 900 MHz band or a frequency band for PCS (Personal Communications Service) of a 2.4 GHz band. In the event that a signal of a frequency band having a central frequency of 200 MHz is received, the resonant frequency of an antenna is also set to 200 Mhz and the electrical length of a monopole antenna becomes about 37.5 cm. However, when considering a tendency that the sizes of wireless communication terminals, such as DMB phones and DMB receiving terminals, are miniaturized, antennas having a size of 30 cm or more are not practical.

To reduce the size of the antennas, a helical antenna, which is fabricated by forming the monopole antenna in a spiral shape so as to reduce an external size, has been known. However, even if the helical antenna is used, miniaturization of the antenna is limited because of problems such as an increase in an antenna diameter, caused by a reduced antenna size, and an increase in capacitance caused by a reduction in the pitch of helix. In particular, if capacitance increases, radiation efficiency is degraded. It is thus difficult to miniaturize the antenna. In fabrication, the helical antenna has low economical efficiency due to a high failure rate.

As another prior art, there was known a method of extending the electrical length of the antenna by using a multi-staged rod antenna. If the multi-staged rod antenna is used, the length of the antenna can be greatly reduced when it is inserted. However, the multi-staged rod antenna has a long length when being drawn, and has problems in that it is vulnerable to external physical shock and is easily broken by external force. Furthermore, the multi-staged rod antenna can be easily carried because the length thereof is shrunk when it is inserted. However, when the antenna is drawn, the length thereof is extended. Thus, there is substantially no effect of the shrunken antenna size when the antenna is used for the terminal.

Meanwhile, in the case where an antenna radiator is formed on a board such as PCB, there was known a technique of reducing the antenna size by forming the radiator in a meander shape. However, this technique does not have a sufficient antenna miniaturization effect.

### DISCLOSURE OF INVENTION

### Technical Problem

Accordingly, the present invention has been made keeping in mind the above problems occurring in the prior art, and an object of the present invention is to provide an antenna with an extended electrical length, which is suitable for transmission/reception of low frequency signals while maintaining a small size.

Another object of the present invention is to provide an antenna with an extended electrical length, which can maintain good radiation efficiency without increasing the capacitance of the antenna.

Still another object of the present invention is to provide an antenna with an extended electrical length, which can maintain a small size even when being used for wireless communication terminals and can be embedded in terminals.

### Technical Solution

To achieve the above objects, according to an embodiment of the present invention, there is provided an antenna with an extended electrical length, including a board extending in one direction, and a conductive radiator formed in the extending direction of the board on one surface of the board and having one end electrically coupled to a power-feed element, wherein the conductive radiator includes one or more cells having a substantially S-shaped outline.

According to another embodiment of the present invention, there is provided an antenna with an extended electrical length, including a board extending in one direction, and a conductive radiator formed in the extending direction of the board on one surface of the board and having one end electrically coupled to a power-feed element, wherein the conductive radiator includes one or more cells having a substantially spiral shape.

The antenna further includes a ground stub formed on the board so that at least part of the groundstub is electromagnetically connected to the conductive radiator and electrically coupled to a ground surface. The antenna further includes a parasitic element formed on the board so that at least part of the parasitic element is electromagnetically coupled to the conductive radiator. Further, two or more of the cells are preferably connected in series.

Furthermore, preferably, the antenna further includes a conductive connector formed on the other side of the board. One end of each of two or more of the cells is connected to the connector through a through hole. More preferably, the connector has substantially the same shape as that of the cell.

Further, the antenna can further include coating substance formed to cover at least part of the connector and having a dielectric constant higher than that of the board. Preferably, the antenna further includes coating substance formed to cover at least part of the conductive radiator and having a dielectric constant higher than that of the board.

Meanwhile, the antenna preferably further includes a matching element formed on the board and connected between the conductive radiator and the power-feed element. Further, the board can include a Printed Circuit Board (PCB) or a Flexible Printed Circuit Board (FPCB), and two or more of the cells can have different sizes.

The antenna can be disposed at a corner of a ground surface within a wireless communication device and embedded in the wireless communication device.

According to another embodiment of the present invention, the antenna further includes a parasitic element formed on the board and electrically separated from the radiator, and a sliding unit slidingly coupled to the board and having conductive substance, which is electrically connected to the radiator at a contact part when the sliding unit extends.

The sliding unit can have an extension length adjusted in multi-stages when the sliding unit extends. The parasitic element and the sliding unit can be electrically separated from each other when the sliding unit extends. Further, more preferably, the length of the parasitic element can be varied when the sliding unit extends. The antenna can further include a terminal for connection to a terminal of a wireless communication device.

According to still another embodiment of the present invention, there is provided a wireless communication apparatus including the above-mentioned antenna.

### ADVANTAGEOUS EFFECTS

In accordance with the present invention, there is provided an antenna with an extended electrical length, which is suitable for transmission/reception of low frequency signals while maintaining a small size.

Furthermore, according to the present invention, there is provided an antenna with an extended electrical length, which can maintain good radiation efficiency without increasing the capacitance of the antenna, can maintain a small size even when being used for wireless communication terminals and can be embedded in terminals.

In particular, according to the present invention, there is provided an antenna with an electrical length longer than that of an antenna having a meander type radiator and with less noise.

### BRIEF DESCRIPTION OF THE DRAWINGS

Further objects and advantages of the invention can be more fully understood from the following detailed description taken in conjunction with the accompanying drawings in which:

FIG. 1 is a plan view of an antenna according to an embodiment of the present invention;

FIG. 2 is a plan view of a radiator pattern according to another embodiment of the present invention;

FIG. 3 is a plan view of a radiator pattern according to yet another embodiment of the present invention;

FIG. 4 is a plan view of an antenna according to another embodiment of the present invention;

FIG. 5 is a plan view of an antenna according to still another embodiment of the present invention;

FIG. 6 is a view illustrating a state where terminals of an antenna is embedded according to still another embodiment of the present invention;

FIG. 7 is a view illustrating the structure of an antenna according to still another embodiment of the present invention;

FIG. 8 is a dismantled view of the antenna taken along line A-A′ of FIG. 7;

FIG. 9 shows front and rear views of the antenna according to still another embodiment of the present invention; and

FIG. 10 is a view illustrating an extending process of the antenna according to still another embodiment of the present invention.

### MODE FOR THE INVENTION

In this specification, the term “electromagnetic coupling” is used to mean that two elements are electrically isolated from each other with a current path being not formed therebetween, but are disposed with or without dielectric substance intervened therebetween so that mutual currents are induced by electromagnetic waves. The term “electric coupling” is used to mean that two elements are electromagnetically coupled, or have a current path formed therebetween and are coupled together so that electric charges can move mutually.

The present invention will now be described in connection with specific embodiments with reference to the accompanying drawings.

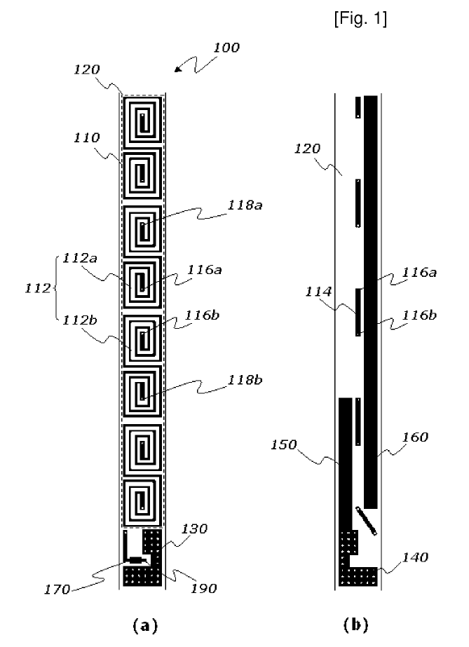

FIG. 1 is a plan view of an antenna according to an embodiment of the present invention. FIG. 1a is a front view of the antenna of the present embodiment and FIG. 1b is a rear view of the antenna of the present embodiment. An antenna 100 includes a board 120 extending in one direction, and a radiator 110 formed in the extending direction of the board 120 on the front surface of the board 120 and having one end electrically coupled to a power-feed element.

The board 120 is formed from dielectric substance and can support the radiator 110. The board 120 is formed of a Printed Circuit Board (PCB) and can have the radiator 110 formed thereon by printing or etching. In this case, the fabrication of the antenna 100 can be facilitated. Alternatively, the board 120 can be formed of a Flexible Printed Circuit Board (FPCB) and can make the antenna further thinner. The board 120 can also serve to reduce an effective wavelength in the radiator 110. In general, the effective wavelength of electromagnetic waves in dielectric substance is

$$\frac{λ}{\sqrt{ɛ}}$$

(λ is the wavelength of electromagnetic waves and ∈ is relative dielectric constant of the dielectric substance). Thus, the effective wavelength of electromagnetic waves can be reduced by using dielectric substance having the relative dielectric constant of 1 or more.

The board 120 can also be formed from ceramics having a high dielectric constant. For example, the board 120 can be formed from BaTiO₃, Ba(Mg_{1/3}Ta_{2/3})O₃ or Ba(Zn_{1/3}Ta_{2/3})O₃-based ceramics having the relative dielectric constant ∈r of about 20 to 120. If ceramics having a high dielectric constant is used, the shrink effect of the wavelength can be obtained and the antenna can be further miniaturized. If dielectric ceramics having a relative dielectric constant exceeding the above range is used, the shrink effect of the wavelength can be expected, too. However, if the relative dielectric constant is 20 or less, it is difficult to miniaturize an overall antenna size because the shrink effect of the wavelength is small. If the relative dielectric constant exceeds 120, dielectric loss or the characteristics of the temperature coefficient are degraded. Thus, a problem may occur because applicability as the board is low. Furthermore, the board 120 can also be formed from organic and inorganic complex materials.

The radiator 110 includes one or more cells 112. Each cell 112 has a substantially S-shaped outline and has both ends disposed within the outline. Accordingly, the size of the cell can be reduced significantly although it has the same electrical length. Furthermore, two or more cells 112 of the radiator 110 can be connected in series. That is, one end of a cell 112a and one end of a cell 112b are connected to form one radiation element on the whole as will be described later on. In particular, when power is feed from the other end of the cell 112b, the antenna can operate as the monopole antenna.

Interconnection of the cells 112a, 112b is described in detail below. The cells 112a, 112b are also formed on the front surface of the board 120, and can have through holes 116a, 116b formed in one ends, respectively. The through holes 116a, 116b are formed on both ends of each connector 114 formed on the rear surface of the board 120. Thus, one end of the cell 112a is connected to one end of the connector 114 through the through hole 116a, and one end of the cell 112b is connected to the other end of the connector 114 through the through hole 116b. Therefore, the cell 112a and the cell 112b are connected in series through the connector 114, thus forming a single electrical path on the whole. Through holes 118a, 118b are also formed in the other ends of the cells 112a, 112b, respectively, and can be connected in series to other neighboring cells in the same manner as above.

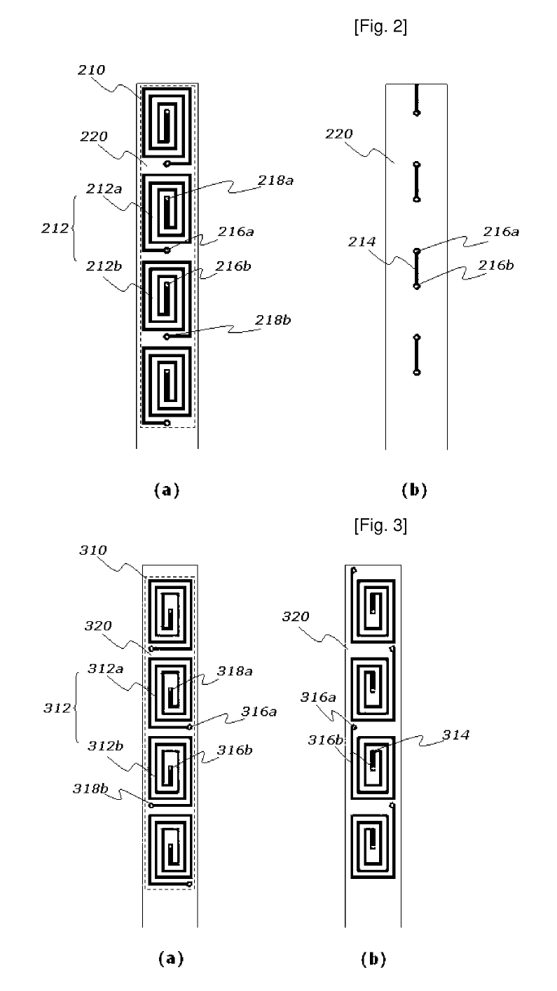

The radiator 110 can have different shapes from that shown in the drawing, and two of various shapes are shown in FIGS. 2 and 3.

FIG. 2 is a plan view of a radiator pattern according to an embodiment of the present invention. FIG. 2a is a front view of the radiator pattern and FIG. 2b is a rear view of the radiator pattern. The radiator 210 of the present embodiment includes one or more cells 212 formed on the front surface of a board 220. Connectors 214 are formed on the rear surface of the board 220. Each cell 212 has a substantially spiral shape, and has one end disposed outside thereof and the other end disposed inside thereof.

Furthermore, two or more cells 212 can be connected in series. In the concrete, through holes 216a, 216b are respectively formed at one ends of cells 212a, 212b, which are connected in series. The through holes 216a, 216b are also formed at both ends of each connector 214 on the rear surface of the board 220. The cell 212a and the cell 212b are connected in series through the connector 214 and form a single electrical path on the whole. Through holes 218a, 218b are also formed in the other ends of the cells 212a, 212b, respectively, and can be connected in series to neighboring cells in the same manner as above.

FIG. 3 is a plan view of a radiator pattern according to another embodiment of the present invention. FIG. 3a is a front view of the radiator pattern of FIG. 3 and FIG. 3b is a rear view of the radiator pattern of FIG. 3. The radiator 310 of the present embodiment also includes substantially spiral cells 312. Each cell 312 has one end formed outside thereof and the other end formed insidethereof. Connectors 314 having substantially the same shape as that of the cell 312 are formed on the rear surface of the board 210. Two or more cells 312a, 312b are connected in series. In this case, through holes 316a, 316b are formed at one ends of the cells 312a, 312b. The through holes 316a, 316b are further formed on both ends of each connector 314, so that the cells 312a and the cell 312b are connected in series through the connector 314. In particular, since the connector 314 has substantially the same as that of the cell 312, the radiator having the electrical length of three or more cells can be formed in a region occupied by two cells. In this case, the PCB, which is relatively thicker than the FPCB, is preferably used as the board 320 to reduce Interference between the connector 314 and the cell 312.

Since the cells on the front surface of the board are connected through the connector on the rear surface of the board as described above, only the cells can be formed on the front surface of the board. It is therefore possible to employ the surface space of the board efficiently and make the antenna smaller. Further, the cells are formed in the extending direction of the board on the board, that is, the radiators are formed in a row on the same plane. Thus, capacitance due to electromagnetic coupling between coils (or cells) is not generated and the radiation efficiency and bandwidth of the antenna can be maintained favorably, unlike the helical antenna in which circular coils are stacked.

Furthermore, since each cell has the spiral shape or S shape, it has less noise compared with the meander type radiator. This noise reduction effect has not been clearly known, but is considered to be resulted from the fact that the radiator having the pattern according to the present invention has less unnecessary radiation compared with the meander type radiator. The effect was confirmed experimentally. In addition, the radiators of the present embodiments can have a further advantageous effect since they have the electrical length, which is about 1.5 times longer than that of the meander type radiator formed on the board having the same size.

Meanwhile, since the S-shaped radiator is used, current directions on and below the cells are the same. Therefore, offset of electromagnetic fields on and below the cells, which appear in the spiral-shaped radiator, can be prevented and radiation efficiency can be improved. Furthermore, if the radiator is miniaturized by using the spiral-shaped radiator, the number of windings is increased, offset of electromagnetic fields on and below the cells is increased and the degradation of radiation efficiency becomes profound. As mentioned above, the S-shaped radiator of the present embodiment is advantageous in terms of miniaturization and radiation efficiency. These effects can be accomplished by using a pair of the spiral-shaped cells with them being wound in opposite directions as shown in FIGS. 2 and 3.

Alternatively, one or more cells can be replaced with a straight-line radiator in order to control the radiation characteristic of the antenna. Furthermore, the radiation pattern of the antenna can be varied by changing the width of a conductive lines within a cell.

Referring back to FIG. 1, the antenna 100 of the present embodiment can include a power-feed stage 190 formed under the board 120 and connected to a power-feed element of the terminal. The power-feed stage 190 can be connected to the cell 112 through a matching element 170. Since the board 120 is formed of the PCB, the matching element 170 can be easily mounted on the board 120 and can perform impedance matching. Accordingly, not only an overall performance of the antenna can be improved, but also miniaturization of the terminal can be realized because the necessity for a matching circuit within the device is obviated.

A ground surface 140 and a ground stub 150 connected to the ground surface 140 can be formed on the rear surface of the board 120. At least part of the ground stub 150 can be overlapped with the radiator 110 on the front surface of the board 120 so that it is coupled to the radiator 110 electromagnetically. Thus, the quality factor of the antenna can be controlled by adjusting the length and/or width of the ground stub 150, and the performance of the antenna can be optimized according to the ground environment of the device.

Furthermore, a parasitic element 160, which is not electrically connected to the radiator 110 and the ground surface 140, can be formed on the rear surface of the board 120. The parasitic element 160 is also at least partially overlapped with the radiator 110 so that it can be electromagnetically coupled to the radiator 110. The parasitic element 160 can have an effect on the resonant frequency and the bandwidth of the antenna due to capacitance formed between the parasitic element 160 and the radiator 110. In particular, the parasitic element 160 can have an effect on a second resonant frequency, and therefore can introduce a multi-band characteristic. As described above, the radiation characteristic of the antenna can be controlled by adjusting the size and location of the parasitic element 160. The parasitic element 160 is described in detail later.

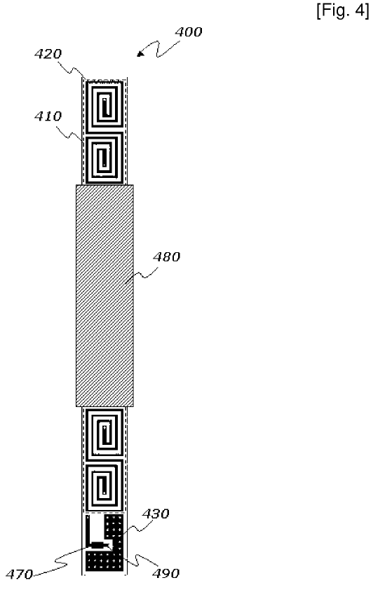

FIG. 4 is a plan view of an antenna according to another embodiment of the present invention. The antenna 400 of the present embodiment further includes coating substance 480 formed to cover not only a board 420 and a radiator 410, but also at least part of the radiator 410 on the board 420. The coating substance 480 can be formed of material having a dielectric constant higher than that of the board 420, preferably Polyphenilyne Sulfide (PPS). PPS is polymer material comprising an aromatic ring and sulfur atoms and is high dielectric material with relative dielectric constant of about 20. PPS can be easily processed by injection molding, etc. and is insensitive to shock. Thus, PPS is suitable for material of the coating substance 480. In particular, PPS has a low dielectric loss at the VHF band, and is appropriate for an antenna for transmitting and receiving the VHF band signal. The arrangement of the coating substance 480 is described in detail in Korean Patent No. 0632692 field by the present applicant. The specification of the above patent is hereby incorporated by reference.

The effective wavelength of electromagnetic waves decreases as the dielectric constant increases as described above. Thus, the extending effect of the electrical length of the radiator 410 can be obtained by disposing the coating substance 480 of a high dielectric constant. In other words, signals of a long wavelength can be transmitted and received by using a smaller antenna. The coating substance can also be disposed on the rear surface of the board 420. In this case, it can contribute to the miniaturization of the antenna.

It has been shown in FIG. 4 that the antenna according to the embodiment of FIG. 1 is used. However, the present embodiment can be implemented by using the antenna having the pattern of the embodiment of FIG. 2 or 3. In particular, in the event that the pattern of the embodiment of FIG. 3 is used, the antenna miniaturization effect by the coating substance disposed on the rear surface of the board is significant.

Furthermore, a partial electrical length extending effect can be obtained by disposing the coating substance in such a way to coat part of a plurality of cells. It can cause a multi-band characteristic as will be described with reference to FIG. 5.

FIG. 5 is a plan view of an antenna according to still another embodiment of the present invention. The embodiment of FIG. 5 basically employs the radiator patterns described in relation to the previous embodiments, but can have different sizes of cells 512a, 512b, and 512c.

At a long wavelength (that is, a low frequency), the whole radiator 510 decides the resonant frequency, but at a short wavelength (that is, a high frequency), each cell 512 can decide the resonant frequency. In this case, the electrical length of the cell 512 can be controlled to change the resonant frequency of a high frequency band. Therefore, the whole size of the cell can be changed to adjust the resonant frequency of the high frequency band, and the antenna can be fabricated in a dual band.

Furthermore, different resonant frequencies can be generated by making the sizes of the cells 512a, 512b, and 512c different as shown in FIG. 5, and the multi-band characteristic can be obtained accordingly. For example, the whole radiator 510 can generate the resonant frequency of the VHF band, the largest cell 512a can generate the resonant frequency of the UHF band, the medium-sized cell 512c can generate the resonant frequency of the cellular band, and the smallest cell 512b can generate the resonant frequency of the PCS band. Thus, the antenna can operate as a triple-band antenna. Alternatively, a cell having another size can also be formed in order to accomplish the multi-band characteristic of a triple-band or more.

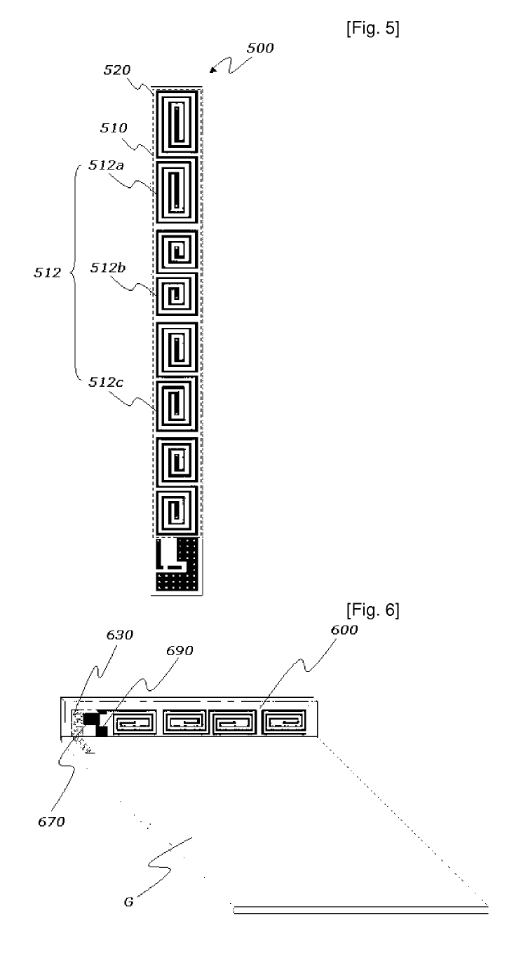

FIG. 6 is a view illustrating a state where an antenna is embedded in device according to still another embodiment of the present invention. As shown in FIG. 6, an antenna 600 in which the radiator of the pattern according to the embodiment of FIG. 1 is formed can be disposed vertically to a ground surface G of a terminal, and a power-feed stage 690 can be connected to a power-feed element (not shown) within the device. Further, as shown in FIG. 6, a ground surface 630 of the antenna 600 can be connected to the ground surface G of the terminal. In this case, the antenna 600 operates as an inverted-F type antenna. Unlike the above arrangement, the antenna can operate as an inverted-L type antenna without connecting the ground surface 630 to the ground surface G of the terminal. The antenna 600 can be fabricated as a very small size as described above, and can be thus easily embedded in the terminal. In particular, radiation shielding by the ground surface G and capacitance between the ground surface G and the radiator can be minimized by disposing the antenna 600 at the corner of the ground surface G. Furthermore, by mounting a matching element 670 on the board, the construction of the device can be simplified without installing the matching element within the device.

The present embodiment has been described above in relation to the antenna 600 employing the radiator pattern of the embodiment of FIG. 1. However, those having ordinary skill in the art will clearly know that the antenna having the radiator pattern shown in FIG. 2 or 3 can be used.

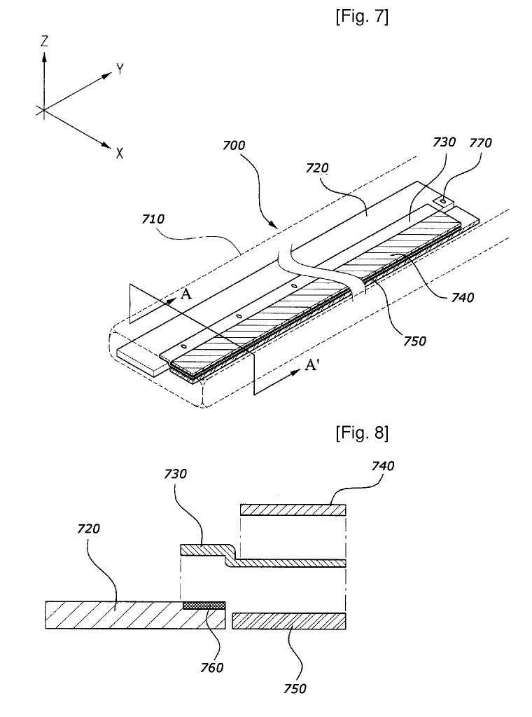

FIG. 7 is a view illustrating the structure of an antenna according to still another embodiment of the present invention. An antenna apparatus 700 according to the present embodiment includes, as shown in FIG. 7, a board 720 having a radiator formed at one end, a sliding unit 730 slidingly coupled to the board 720 and configured to vary the length of the radiator, and a first bedplate 740 and a second bedplate 750 configured to support the movement of the sliding unit 730 when the sliding unit 730 extends or shrinks.

The sliding unit 730 can be extended or shrunk in a Y-axis direction, and the first and second bedplates 740, 750 support the sliding unit 730 when it moves. However, it is to be noted that the shape and number of the bedplates are not limited to the above embodiment, but can be varied or modified in various ways within the scope that is evident to those having ordinary skill in the art.

The sliding unit 730 includes a conductive unit so that the sliding unit 730 can serve as a parasitic element or a stub as will be described later on. In an embodiment, the sliding unit 730 can be formed by using the same material as that of the board 720, and can have conductive substance printed, etching or deposited on its surface. Alternatively, the sliding unit 730 can be made of a conductor.

Meanwhile, the parasitic element (refer to reference numeral 760 of FIG. 8) can be formed at a portion where the board 720 is brought in contact with the sliding unit 730. The parasitic element 760 generally refers to a conductive portion that is not directly connected to the power-feed line. The parasitic element 760 can increase the bandwidth of the antenna and improve the quality factor.

In general, a Planar Inverted F Antenna (PIFA) or a microstrip antenna has a narrow bandwidth. To overcome the shortcoming, a conductor is disposed near the radiator directly coupled to the power-feed stage so that part of energy radiated from the radiator is induced to the parasitic element 760. Accordingly, resonance can be generated once more at a neighboring frequency generally higher than the resonant frequency of the radiator), and an overall bandwidth can be increased.

Further, in the case of the DMB antenna for receiving the VHF band, an antenna pattern can be twisted excessively in order to generate resonance at a relatively low frequency band of 200□. For this reason, a region where current flows on the surface of the antenna cross each other exists inevitably. Thus, when energy is radiated, a portion where the energy is offset at a far-field region exists. Accordingly, there are problems in that radiation efficiency reduces and the bandwidth shrinks. In order to supplement this problem, the parasitic element 760 electromagnetically coupled to the radiator can be disposed at a portion near the radiator so as to increase the bandwidth of the radiator.

The radiator can have the spiral-shaped or S-shaped outline, as described in the embodiments, in order to shrink the rod antenna having a long length. In this case, the inductance component increases and the capacitance component decreases, so that the quality factor and the reflection loss value can be reduced on the whole. Examining this phenomenon from the viewpoint of an equivalent circuit, the antenna of the present embodiment can be made equivalent to a parallel LC resonant circuit. The inductance component and the capacitance component of the frequency band in which resonance will be generated are difficult to be made symmetrical to each other due to the spiral-shaped radiator, which makes efficient resonance impossible. To solve the problem, the parasitic element 760 is disposed in a region close to the radiator. Therefore, resonance can be generated efficiently due to the capacitance component generated between the radiator and the parasitic element 760.

The parasitic element 760 can be preferably disposed near a region where energy is concentrated. The capacitance component may not be necessary, if appropriate. Thus, the size, distance, etc. of the parasitic element 760 can be varied depending on a desired performance of a mobile phone. In an embodiment, the parasitic element 760 of the antenna can generate resonance at a desired frequency by controlling the length with the distance and width being fixed.

The parasitic element 760 can be formed at a portion of the board 720, and can operate separately from the sliding unit 730 when the sliding unit 730 is extended. The size, length, etc. of the parasitic element 760 can be varied depending on a desired performance of a mobile phone. When the sliding unit 730 shrinks, the parasitic element 760 and the sliding unit 730 become short and both the parasitic element 760 and the sliding unit 730 can operate as the parasitic element 760.

Meanwhile, according to the present invention, since the antenna can be fabricated as a thin type PCB, the frequency can be controlled by forming a matching circuit in the power-feed unit. In more detail, an insufficient reception level can be reinforced by adding a Low Noise Amplifier (LNA) including the matching circuit.

The respective constituent elements can be mounted within an external casing 710 and can be connected to a communication terminal in a detachable manner, or can be inserted into the communication terminal body and can be integrated with the communication terminal. In the case where the antenna is formed in a detachable manner, the antenna can further include a terminal for connection to a terminal of the communication terminal.

FIG. 8 is a dismantled view of the antenna taken along line A-A′ of FIG. 7. As shown in FIG. 8, the sliding unit 730 has a central portion curved twice and has a Z shape. The sliding unit 730 touches the board 720 including the parasitic element 760 in a parallel manner and can thus move in the Y-axis direction of FIG. 7.

The parasitic element 760 made of conductive material can be formed at a portion where it is brought in contact with the sliding unit 730, of the surface of the board 720. As described above, the parasitic element 760 can enhance the capacitance component of the antenna pattern and improve the quality factor of the antenna.

The sliding unit 730 can also be made of conductive material. Thus, when the sliding unit 730 shrinks, the sliding unit 730 can be brought in touch with the parasitic element 760 as will be described later on, so that the whole sliding unit 730 can operate as the parasitic element 760. When the sliding unit 730 extends, the sliding unit 730 can be used as the extension unit of the spiral-shaped coil pattern. The sliding unit 730 can have its surface formed of conductive substance as described above.

Meanwhile, a second bedplate 750 is formed under the sliding unit 730 adjacent to the parasitic element. The sliding unit 730 and the first bedplate 740 are sequentially formed vertically above the second bedplate 750. The first and second bedplates 740, 750 to support the sliding unit 730 are formed of non-conductor in the same manner as the board 720.

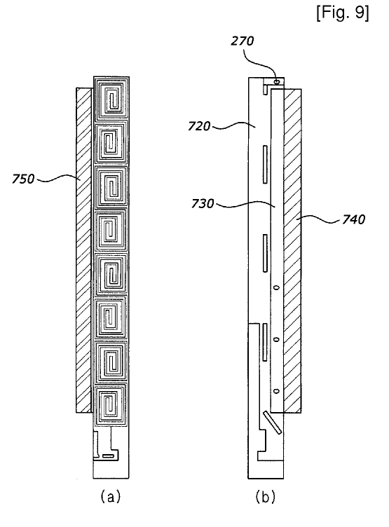

FIG. 9 shows front and rear views of the antenna according to still another embodiment of the present invention. FIG. 9a is a front view of the antenna according to the spirit of the present invention. Referring to FIG. 9a, the radiator can have several cells having a S-shaped outline in order to receive a DMB signal of about 170 to 210 MHz. The maximum radiator length can be secured at a narrow area by using the cells. Alternatively, the patterns of various radiator used in the embodiments can be used.

The power-feed stage or the ground terminal of the antenna pattern can be formed on one surface of the board 720 or can be formed on both ends of the board 720. Further, the power-feed stage or the ground terminal can be stacked or buried to form the board 720. Further, the second bedplate 750 can be formed on one surface of the board 720.

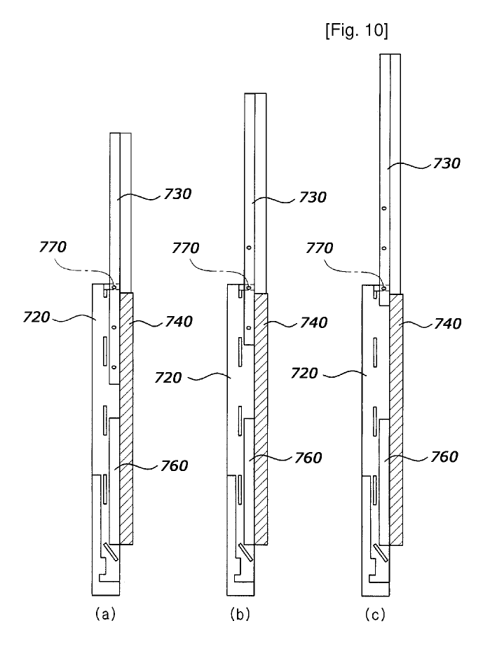

Meanwhile, FIG. 9b is a rear view of the antenna according to the spirit of the present invention. Referring to FIG. 9b, the antenna includes the board 720, the sliding unit 730 formed on the rear surface of the board 720 and configured to increase the length of the antenna pattern, and the first bedplate 740 for supporting the movement of the sliding unit 730 when the sliding unit 730 extends or shrinks. A contact part 770 is formed on a path along which the sliding unit 730 extends. The contact part 770 can be formed on the board 720 and can increase the length of the radiator by making the sliding unit 730 electrically connected to the radiator. Preferably, a projection can be formed in the contact part 770 and a concave unit can be formed in the sliding unit 730. The length of the sliding unit 730 can be adjusted by gearing the projection to the concave unit together. The parasitic element (refer to reference numeral 760 of FIG. 10) can be formed under the sliding unit 730. The parasitic element 760 can be exposed externally when the sliding unit 730 extends. A process of extending the sliding unit 730 is described in detail below with reference to FIG. 10.

FIG. 10 is a view illustrating the extending process of the antenna according to still another embodiment of the present invention. Referring to FIG. 10, whether the sliding unit 730 will be extended and the degree in which the sliding unit 730 will be extended are decided according to a frequency band to be received through the antenna. If it is sought to receive a frequency of a high band, the sliding unit 730 is not extended as shown in FIG. 9b, and the sliding unit 730 electrically separated from the radiator operates as the parasitic element 760 not the extension unit of the radiator. If it is sought to receive a frequency of a lower band, the sliding unit 730 can be extended in stages, and a plurality of concave units can be formed in the sliding unit 230 so that the sliding unit 230 can be extended in a multi-stage manner, as shown in FIGS. 10a to 10c. In the concrete, the sliding unit 230 can be extended in three stages, and a specific portion of the sliding unit 230 is connected to the contact part 770 of the board 220, so that the extended part can be used as the extension unit of the radiator. In other words, when the sliding unit 730 shrinks, the whole sliding unit 730 operates as the parasitic element 760. When the sliding unit 730 extends, the sliding unit 730 is separated from the parasitic element 760 and is then connected to the radiator, so that the top of the contact part 770 extends the length of the radiator and the remaining contact part 770 operates as a stub.

### INDUSTRIAL APPLICABILITY

In accordance with the present invention, there is provided an antenna with an extended electrical length, which is suitable for transmission/reception of low frequency signals while maintaining a small size.

Furthermore, according to the present invention, there is provided an antenna with an extended electrical length, which can maintain good radiation efficiency without increasing the capacitance of the antenna, can maintain a small size even when being used for wireless communication terminals and can be embedded in terminals.

In particular, according to the present invention, there is provided an antenna with an electrical length longer than that of an antenna having a meander type radiator and with less noise.

Although the present invention has been described in connection with the specific embodiments, the present invention is not limited to the embodiments and should be interpreted to have the widest range according to the basic spirit disclosed in the specification. Those skilled in the art can easily change the materials, sizes, etc. of the respective constituent elements depending on their application fields, and can easily change the size of the radiator depending on the frequency band of a signal used. Furthermore, patterns having shapes not disclosed in the specification can be implemented by combining/substituting the disclosed embodiments which fall within the scope of the present invention. In addition, those skilled in the art can easily change the disclosed embodiments based on the specification. It is evident that such modifications and alternations also fall within the scope of the present invention.

1. An antenna with an extended electrical length comprising: a board extending in one direction; and a conductive radiator formed in the extending direction of the board on one surface of the board and having one end electrically coupled to a power-feed element, wherein the conductive radiator includes one or more cells having a substantially S-shaped outline.

2. (canceled)

3. The antenna of claim 1, further comprising a ground stub formed on the board so that at least part of the ground stub is electromagnetically coupled to the conductive radiator and electrically connected to a ground surface.

4. The antenna of claim 1, further comprising a parasitic element formed on the board so that at least part of the parasitic element is electromagnetically coupled to the conductive radiator.

5. The antenna of claim 1, wherein two or more of the cells are connected in series.

6. The antenna of claim 1 further comprising a conductive connector formed on the other side of the board, wherein one end of each of two or more of the cells is connected to the connector through a through hole.

7. The antenna of claim 6, wherein the connector has substantially the same shape as that of the cell.

8. The antenna of claim 6, further comprising coating substance formed to cover at least part of the connector and having a dielectric constant higher than that of the board.

9. The antenna of claim 1, further comprising coating substance formed to cover at least part of the conductive radiator and having a dielectric constant higher than that of the board.

10. The antenna of claim 1, further comprising a matching element formed on the board and connected between the conductive radiator and the power-feed element.

11. The antenna of claim 1, wherein the board includes a Printed Circuit Board (PCB) or a Flexible Printed Circuit Board (FPCB).

12. The antenna of claim 1, wherein two or more of the cells have different sizes.

13. The antenna of claim 1, wherein the antenna is disposed at a corner of a ground surface within a wireless communication device and embedded in the wireless communication device.

14. The antenna of claim 1, further comprising: a parasitic element formed on the board and electrically separated from the radiator; and a sliding unit slidingly coupled to the board and having conductive substance, which is electrically connected to the radiator at a contact part when the sliding unit extends.

15. The antenna of claim 14, wherein the sliding unit has an extension length adjusted in multi-stages when the sliding unit extends.

16. The antenna of claim 14, wherein the parasitic element and the sliding unit are electrically separated from each other when the sliding unit extends.

17. The antenna of claim 16, wherein a length of the parasitic element is varied when the sliding unit extends.

18. The antenna of claim 14, further comprising a terminal for connection to a terminal of a wireless communication device.

19. A wireless communication apparatus including an antenna with an extended electrical length according to claim 1.

20. An antenna with an extended electrical length comprising: a board extending in one direction; and a conductive radiator formed in the extending direction of the board on one surface of the board and having one end electrically coupled to a power-feed element, wherein the conductive radiator includes one or more cells having a substantially spiral shape.

21. The antenna of claim 20, further comprising a ground stub formed on the board so that at least part of the ground stub is electromagnetically coupled to the conductive radiator and electrically connected to a ground surface.

22. The antenna of claim 20, further comprising a parasitic element formed on the board so that at least part of the parasitic element is electromagnetically coupled to the conductive radiator.

23. The antenna of claim 20, wherein two or more of the cells are connected in series.

24. The antenna of claim 20, further comprising a conductive connector formed on the other side of the board, wherein one end of each of two or more of the cells is connected to the connector through a through hole.

25. The antenna of claim 24, wherein the connector has substantially the same shape as that of the cell.

26. The antenna of claim 24, further comprising coating substance formed to cover at least part of the connector and having a dielectric constant higher than that of the board.

27. The antenna of claim 20, further comprising coating substance formed to cover at least part of the conductive radiator and having a dielectric constant higher than that of the board.

28. The antenna of claim 20, further comprising a matching element formed on the board and connected between the conductive radiator and the power-feed element.

29. The antenna of claim 20, wherein the board includes a Printed Circuit Board (PCB) or a Flexible Printed Circuit Board (FPCB).

30. The antenna of claim 20, wherein two or more of the cells have different sizes.

31. The antenna of claim 20, wherein the antenna is disposed at a corner of a ground surface within a wireless communication device and embedded in the wireless communication device.

32. The antenna of claim 20, further comprising: a parasitic element formed on the board and electrically separated from the radiator, and a sliding unit slidingly coupled to the board and having conductive substance, which is electrically connected to the radiator at a contact part when the sliding unit extends.

33. The antenna of claim 32, wherein the sliding unit has an extension length adjusted in multi-stages when the sliding unit extends.

34. The antenna of claim 32, wherein the parasitic element and the sliding unit are electrically separated from each other when the sliding unit extends.

35. The antenna of claim 34, wherein a length of the parasitic element is varied when the sliding unit extends.

36. The antenna of claim 32, further comprising a terminal for connection to a terminal of a wireless communication device.

37. A wireless communication apparatus including an antenna with an extended electrical length according to claim 20.
